(19) United States
(12) Patent Application Publication
(10) Pub. No.: US 2019/0215914 A1
(43) Pub. Date: Jul. 11, 2019

(54) DRAWER-TYPE MICROWAVE OVEN, AND DOOR OPENING AND CLOSING CONTROL METHOD THEREFOR

(71) Applicants: GUANGDONG MIDEA KITCHEN APPLIANCES MANUFACTURING CO., LTD., Foshan (CN); MIDEA GROUP CO., LTD., Foshan (CN)

(72) Inventors: Xiaojin ZHOU, Foshan (CN); Jianyi Zhou, Foshan (CN); Yongzhong Zhang, Foshan (CN); Leilei Zhang, Foshan (CN)

(21) Appl. No.: 16/355,337

(22) Filed: Mar. 15, 2019

Related U.S. Application Data
(63) Continuation of application No. PCT/CN2016/112187, filed on Dec. 26, 2016.

(30) Foreign Application Priority Data
Sep. 18, 2016 (CN) 201610830256.4

(51) Int. Cl. H05B 6/64; H05B 6/68; H05B 6/70; H05B 6/80

(52) U.S. Cl. CPC H05B 6/6417; H05B 6/687; H05B 2206/04; H05B 6/707; H05B 6/80; H05B 6/681

(57) ABSTRACT

A drawer-type microwave oven (200), and a door opening and closing control method for the drawer-type microwave oven (200). The drawer-type microwave oven (200) comprises: a cavity assembly; a drawer assembly, provided in the cavity assembly and used for containing food to be processed; a push rod assembly (2062), provided at the bottom of the cavity assembly and capable of pushing the drawer assembly out of or into the cavity assembly; a control panel (220), disposed on the cavity assembly, and provided with an “on/off” button for controlling the drawer assembly to be opened or closed; and a microprocessor (202), connected to the push rod assembly (2062) and/or the control panel (220) and used for controlling the operating state of the push rod assembly (2062) according to an instruction of the control panel (220). Automatic door opening and closing of the drawer-type microwave oven (200) can be controlled with one button. Moreover, when the drawer (2044) is moving, the button can be pressed for emergency braking. Thus, a plurality of operations can be implemented using only one button. The present invention is easy to operate and safe to use.

The present disclosure claims the priority of the Chinese patent application No. 201610830256.4, filed with the China National Intellectual Property Administration on Sep. 18, 2016 and entitled “Drawer-type Microwave Oven, and Door Opening and Closing Control Method Therefor”, which is incorporated herein by reference in its entirety.

### TECHNICAL FIELD

The present disclosure relates to the field of cooking appliances, and particularly to a drawer-type microwave oven, and a door opening and closing control method for the drawer-type microwave oven.

### BACKGROUND ART

In the related art, for drawer-type microwave ovens, door opening or closing is generally controlled in a manual way, and a user sometimes gets his fingers caught when he is not paying attention, which has certain impact on the user's safety while affecting the user's use experience. In addition, when the existing drawer-type microwave ovens adopt electric control for door opening or closing, the general practice is to use two buttons to control the automatic opening and the automatic closing of the drawer, respectively. However, for this solution, the two buttons coexist and need to occupy the place of two buttons; moreover, at the time of expanding the functions of a microwave oven, the existing buttons are not enough, and it is necessary to increase the number of buttons, which brings forth great inconvenience. Further, the coexistence of the two buttons also limits the flexibility of industrial design and appearance design.

### SUMMARY

The present disclosure aims to solve at least one of the technical problems existing in the prior art or in the related art.

To this end, one object of the present disclosure is to provide a drawer-type microwave oven.

The other object of the present disclosure is to provide a door opening and closing control method for the drawer-type microwave oven.

To achieve the above objects, according to an embodiment of the first aspect of the present disclosure, there is provided a drawer-type microwave oven, comprising: a cavity assembly; a drawer assembly, provided in an interior of the cavity assembly and used for containing food to be processed; a push rod assembly, provided at the bottom of the interior of the cavity assembly and capable of pushing the drawer assembly out of or into the cavity assembly; a control panel, disposed on the cavity assembly, and provided with an “on/off” button for controlling the drawer assembly to be opened or closed; and a microprocessor, provided in the interior of the cavity assembly, connected to the push rod assembly and/or the control panel and used for controlling the operating state of the push rod assembly according to an instruction of the control panel.

In the drawer-type microwave oven according to an embodiment of the present disclosure, in the interior of the cavity assembly are provided a push rod assembly for pushing the drawer assembly out of or into the cavity assembly and a control panel connected to a microprocessor. On the one hand, the user can realize the function of automatic opening and the function of automatic closing only by operating one button; and on the other hand, in order to ensure the safety of the user, in the process of opening or closing the drawer assembly, if the user intends to stop the operation of the drawer assembly immediately, he only needs to press the button, then the control of stopping the operation of the drawer assembly can be realized.

In the above, multiple functions may further be set on the control panel according to different needs of the user, so as to accomplish the function of selecting different cooking modes to cook or process the food to be processed. The microprocessor may control the operating state of the push rod assembly according to an instruction from the control panel, and the microprocessor automatically analyzes the position information of the current drawer assembly, and controls, through the push rod assembly, opening or closing of the drawer assembly. After the instruction is obtained, the whole control process does not require any manual operation by the user, and the automatic operation reduces the possibility that the user is physically injured due to improper operation.

According to one embodiment of the present disclosure, preferably, the drawer assembly comprises:

a drawer door body with an upper surface being parallel to a lower surface of the control panel;

a drawer for containing and processing the food to be processed;

at least one door hook provided on a rear side of the drawer door body and used for preventing the drawer assembly from ejecting at the time of processing the food to be processed; and

a connection plate connected to the drawer door body and used for enabling the drawer to move according to a preset track when the drawer is pulled out or returned to its original position.

In this embodiment, at least one door hook is provided on the rear side of the drawer door body, which can reduce the possibility of ejection of the drawer assembly when the drawer-type microwave oven processes the food to be processed. Moreover, a connection plate connected to the drawer door body is further provided, which can limit the movement track and the movement length when the drawer is pulled out or returned to its original position, reduce physical injuries of the user when the user does not pay attention to the extension amount of the drawer after pressing the button, and further improve the user's experience and use safety.

According to one embodiment of the present disclosure, the drawer door body further comprises:

a transparent window for displaying a cooking state of the food to be processed; and a handle for manually pulling out the drawer or manually restoring the drawer.

In this embodiment, a transparent window for displaying a cooking state of the food is provided on the drawer door body, and the user can observe the cooking state of the food through the transparent window so as to make a selection. For example, the user selects the defrosting function, but he does not know the time required for defrosting the food, then he selects 5 minutes, when defrosting has been performed for 3 minutes, the user observes, through the transparent window, that the food has been completely defrosted, and then he can stop the defrosting operation so as to perform subsequent processing on the food. In addition, when a sudden power failure occurs during use of the microwave oven, the user can open the drawer door body by the handle, and take out the food to be processed, which reflects functional diversity.

According to one embodiment of the present disclosure, the push rod assembly comprises: a push rod connected to the drawer door body; a motor that drives the drawer under the control of the microprocessor; and a pusher provided at the bottom of the interior of the cavity assembly and connected to the motor and the push rod to drive the push rod under the driving of the motor.

In this embodiment, the microprocessor controls, by collecting the signals of the control panel, the motor to rotate forwardly or reversely, and the interior of the pusher is composed of a transmission device, which is capable of converting the circular motion of the motor into the rectilinear motion of the push rod, i.e., by controlling the motor to rotate forwardly, it is possible to push out the push rod, thereby pushing out the drawer to realize the opening of the drawer assembly, and similarly, by controlling the motor to rotate reversely, it is possible to retract the push rod, thereby retracting the drawer to realize the closing of the drawer assembly. It will be appreciated by those skilled in the art that the forward rotation and the reverse rotation of the motor herein do not limit the realization of the operations of pushing out and retracting the push rod, respectively, and that the transmission device may be realized by, but not limited to, worm gearing.

According to the embodiment of the present disclosure described above, the cavity assembly comprises:

a magnetron for generating microwaves for processing the food to be processed;

a waveguide tube located at the top of the interior of the cavity assembly, connected to the magnetron and used for transmitting ultra-high frequency electromagnetic waves; and

a fan assembly that performs forced air-cooling heat dissipation on the magnetron to prevent the magnetron from overheating damage.

In this embodiment, a waveguide tube connected to a magnetron is provided at the top of the interior of the cavity assembly, the magnetron can form, by the cathode and anode thereof, a space in which electrons interact with a high-frequency electromagnetic field, microwaves are generated in this space, and the waveguide tube transmits the generated microwaves into the cavity, such that the microwaves are absorbed by the food to be processed, thereby accomplishing the function of heating, defrosting or the like. Moreover, since the magnetron also generates a large amount of heat while generating microwaves, a fan assembly is further provided, and in order to prolong the service life of the magnetron, the fan assembly performs forced air-cooling heat dissipation on the magnetron during the operation of the magnetron to maintain the stability of the operation of the magnetron, and reduce the possibility that the magnetron is damaged because too much heat accumulates on the magnetron and cannot be dissipated.

According to the embodiment of the present disclosure described above, the cavity assembly further comprises:

a cavity for receiving the drawer;

a guide rail connected to the drawer door body through the connection plate and used for providing a path for the pulling-out or restoring of the drawer;

at least one interlock bracket provided in the cavity and in one-to-one correspondence with the at least one door hook; at least one limit block provided at the bottom of the drawer and used for limiting the opening degree of the drawer assembly;

a first microswitch that is connected to the microprocessor and is closed and feeds back a signal to the microprocessor, when the drawer assembly is opened to a maximum extent; and

a second microswitch that is connected to the microprocessor, and is closed and feeds back a signal to the microprocessor, when the door hook is coupled to the interlock bracket.

In this embodiment, the guide rail connected to the drawer door body through the connection plate provides a path for the pulling-out or retraction of the drawer; moreover, at least one limit block is provided at the bottom of the drawer, which can limit the maximum pulling-out length of the drawer assembly to reduce the physical injuries to the user when the drawer is pulled out. Further, it is also feasible to provide a limit block on each of the two sides of the bottom of the drawer, so that when pulled out to the maximum extent along the guide rail, the drawer maintains the uniformity of moving of the two sides thereof, and the possibility of the occurrence of the case where the drawer is pulled out with one side being longer than the other side is reduced.

Moreover, there are also provided a first microswitch and a second microswitch, wherein the first microswitch can be regarded as an opening detection switch, when the drawer assembly is pulled out to the maximum stroke, the limit block touches the first microswitch provided on the interlock bracket, at this time, the first microswitch is closed and transmits a closing signal to the microprocessor, and the microprocessor determines that the drawer assembly is in the maximum opened state at this time;

the second microswitch may be regarded as a closing detection switch, when the drawer assembly is closed, the door hook is mated with the interlock bracket, and the second microswitch is triggered at the same time, at this time, the second microswitch is closed and transmits a closing signal to the microprocessor, and the microprocessor determines that the drawer assembly is in the closed state at this time.

In the above, the second microswitch may be a microswitch specifically provided for detecting the closing of the drawer, or a primary interlock switch, a secondary interlock switch, a monitor switch or the like of the drawer-type microwave oven itself may also be used as the second microswitch.

An embodiment of the second aspect of the present disclosure provides a door opening and closing control method for the drawer-type microwave oven, comprising the following steps:

step 102, detecting, after receiving a designated signal, the opened/closed state of the drawer assembly of the drawer-type microwave oven according to the opened/closed state of the first microswitch and the second microswitch; and

step 104, opening/closing the drawer assembly according to the opened/closed state of the drawer assembly.

In this embodiment, after the user touches the button located on the control panel, the microprocessor will detect the opened/closed state of the first microswitch and the second microswitch, thereby controlling, by analyzing the state of the two microswitches, the push rod assembly to push out or retract the drawer.

According to an embodiment of the second aspect of the present disclosure, step 102 further comprises:

if the first microswitch is in the closed state, the drawer assembly being in the maximum opened state;

if the second microswitch is in the closed state, the drawer assembly being in the closed state; and

if both the first microswitch and the second microswitch are in the opened state, the drawer assembly being in the opened state but not opened to the maximum extent.

According to an embodiment of the second aspect of the present disclosure, step 104 further comprises: closing the drawer assembly if the drawer assembly is in the maximum opened state; opening the drawer assembly to the maximum extent if the drawer assembly is in the closed state; and opening the drawer assembly to the maximum extent if the drawer assembly is in the opened state, but is not opened to the maximum extent.

Specifically, the state analysis process and the determination operation are as shown in Table 1.

TABLE 1

| state of | state of | | |
|---|---|---|---|
| the first | the second | initial drawer | push rod |
| microswitch | microswitch | state | control operation |
| opened | opened | opened state | opening the |
| | | | drawer assembly |
| | | | to the maximum |
| | | | opened extent |
| opened | closed | closed state | pushing out and |
| | | | opening the |
| | | | drawer assembly |
| closed | opened | maximum opened | retracting and |
| | | state | closing the |
| | | | drawer assembly |

According to an embodiment of the second aspect of the present disclosure, the door opening and closing control method for the drawer-type microwave oven further comprises: if receiving the designated signal during the moving process, the drawer assembly immediately stopping moving.

In this embodiment, during use, in the moving process of the drawer assembly, when the user realizes that the food previously placed is the wrong food, he may press the button, then the microcontroller immediately controls, by determining that the drawer is currently moving and the first microswitch and the second microswitch are not touched, the push rod assembly to stop moving and wait for the next instruction, which improves the use safety of the user, while improving the user experience.

Additional aspects and advantages of the present disclosure will partially be set forth in the following description, and will partially become obvious from the following description, or learned by the practice of the present disclosure.

### BRIEF DESCRIPTION OF DRAWINGS

The above-mentioned and/or additional aspects and advantages of the present disclosure will become apparent and be understood easily from the following description of the embodiments made in conjunction with the accompanying drawings, in which:

FIG. 1 is an external schematic view of a drawer-type microwave oven according to an embodiment of the present disclosure;

FIG. 2 is an internal schematic view of the drawer-type microwave oven according to an embodiment of the present disclosure;

FIG. 3 is a schematic diagram of embodiment I of the drawer-type microwave oven according to the present disclosure;

FIG. 4 is a schematic diagram of embodiment II of the drawer-type microwave oven according to the present disclosure; and

FIG. 5 is a schematic flow diagram of determination according to an embodiment of the second aspect of the present disclosure.

### DETAILED DESCRIPTION OF EMBODIMENTS

In order that the above-mentioned objectives, features and advantages of the present disclosure can be understood more clearly, a further detailed description of the present disclosure will be given below in connection with the accompanying drawings and embodiments. It should be noted that the embodiments of the present disclosure and the features of the embodiments can be combined with each other if there is no conflict. In the following description, numerous specific details are set forth in order to provide a thorough understanding of the present disclosure. However, the present disclosure can also be implemented in other manners than those described herein. Therefore, the protection scope of the present disclosure is not limited to the specific embodiments disclosed below.

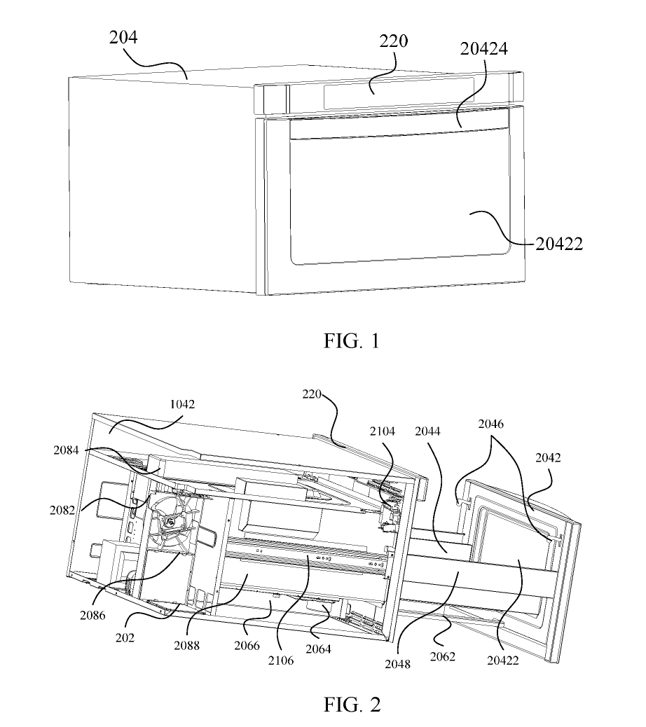

A drawer-type microwave oven 200 and a door opening and closing control method therefor according to the embodiments of the present disclosure are described in detail below with reference to FIG. 1 to FIG. 5.

As shown in FIGS. 1-4, the drawer-type microwave oven 200 according to an embodiment of the present disclosure comprises:

a cavity assembly; a drawer assembly, provided in an interior of the cavity assembly and used for containing food to be processed;

a push rod 2062 assembly, provided at the bottom of the interior of the cavity assembly and capable of pushing the drawer assembly out of or into the cavity assembly;

a control panel 220, disposed on the cavity assembly, and provided with an “on/off” button for controlling the drawer assembly to be opened or closed; and

a microprocessor 202, provided in the interior of the cavity assembly, connected to the push rod 2062 assembly and/or the control panel 220 and used for controlling the operating state of the push rod 2062 assembly according to an instruction of the control panel 220.

In the drawer-type microwave oven 200 according to an embodiment of the present disclosure, in the interior of the cavity assembly are provided the push rod 2062 assembly for pushing the drawer assembly out of or into the cavity assembly and the control panel 220 connected to the microprocessor 202. On the one hand, the user can realize the function of automatic opening and the function of automatic closing only by operating one button; and on the other hand, in order to ensure the safety of the user, in the process of opening or closing the drawer assembly, if the user intends to stop the operation of the drawer assembly immediately, he only needs to press the button, then the control of stopping the operation of the drawer assembly can be realized.

In the above, multiple functions may further be set on the control panel 220 according to different needs of the user, so as to accomplish the function of selecting different cooking modes to cook or process the food to be processed. The microprocessor 202 may control the operating state of the push rod 2062 assembly according to an instruction from the control panel 220, and the microprocessor 202 automatically analyzes the position information of the current drawer assembly, and controls, through the push rod 2062 assembly, opening or closing of the drawer assembly. After the instruction is obtained, the whole control process does not require any manual operation by the user, and the automatic operation reduces the possibility that the user is physically injured due to improper operation. As shown in FIGS. 2-4, the embodiments according to the first aspect of the present disclosure may further include the following embodiments:

according to one embodiment of the present disclosure as shown in FIG. 2, preferably, the drawer assembly comprises:
a drawer door body 2042 with an upper surface being parallel to a lower surface of the control panel 220; a drawer 2044 for containing and processing the food to be processed;
at least one door hook 2046 provided on a rear side of the drawer door body 2042 and used for preventing the drawer assembly from ejecting at the time of processing the food to be processed; and
a connection plate 2048 connected to the drawer door body 2042 and used for enabling the drawer 2044 to move according to a preset track when the drawer is pulled out or returned to its original position.

In this embodiment, at least one door hook 2046 is provided on the rear side of the drawer door body 2042, which can reduce the possibility of ejection of the drawer assembly when the drawer-type microwave oven 200 processes the food to be processed. Moreover, the connection plate 2048 connected to the drawer door body 2042 is further provided, which can limit the movement track and the movement length when the drawer 2044 is pulled out or returned to its original position, reduce physical injuries of the user when the user does not pay attention to the extension amount of the drawer 2044 after pressing the button, and further improve the user's experience and use safety.

According to one embodiment of the present disclosure, the drawer door body 2042 further comprises:

a transparent window 20422 for displaying a cooking state of the food to be processed; and

a handle 20424 for manually pulling out the drawer 2044 or manually restoring the drawer 2044.

In this embodiment, the transparent window 20422 for displaying a cooking state of the food is provided on the drawer door body 2042, and the user can observe the cooking state of the food through the transparent window 20422 so as to make a selection. For example, the user selects the defrosting function, but he does not know the time required for defrosting the food, then he selects 5 minutes, when defrosting has been performed for 3 minutes, the user observes, through the transparent window 20422, that the food has been completely defrosted, and then he can stop the defrosting operation so as to perform subsequent processing on the food. In addition, when a sudden power failure occurs during use of the microwave oven, the user can open the drawer door body 2042 by the handle 20424, and take out the food to be processed, which reflects functional diversity.

According to one embodiment of the present disclosure, the push rod 2062 assembly comprises:

a push rod 2062 connected to the drawer door body 2042;

a motor 2064 that drives the drawer 2044 under the control of the microprocessor 202; and

a pusher 2066 provided at the bottom of the interior of the cavity assembly and connected to the motor 2064 and the push rod 2062 to drive the push rod 2062 under the driving of the motor 2064.

In this embodiment, the microprocessor 202 controls, by collecting the signals of the control panel 220, the motor 2064 to rotate forwardly or reversely, and the interior of the pusher 2066 is composed of a transmission device, which is capable of converting the circular motion of the motor 2064 into the rectilinear motion of the push rod 2062, i.e., by controlling the motor 2064 to rotate forwardly, it is possible to push out the push rod 2062, thereby pushing out the drawer 2044 to realize the opening of the drawer assembly, and similarly, by controlling the motor 2064 to rotate reversely, it is possible to retract the push rod 2062, thereby retracting the drawer 2044 to realize the closing of the drawer assembly. It will be appreciated by those skilled in the art that the forward rotation and the reverse rotation of the motor 2064 herein do not limit the realization of the operations of pushing out and retracting the push rod 2062, respectively, and that the transmission device may be realized by, but not limited to, worm gearing.

According to one embodiment of the present disclosure, the cavity assembly comprises: a magnetron 2082 for generating microwaves for processing the food to be processed; a waveguide tube 2084 located at the top of the interior of the cavity assembly, connected to the magnetron 2082 and used for transmitting ultra-high frequency electromagnetic waves; and a fan assembly 2086 that performs forced air-cooling heat dissipation on the magnetron 2082 to prevent the magnetron 2082 from overheating damage.

In this embodiment, the waveguide tube 2084 connected to the magnetron 2082 is provided at the top of the interior of the cavity assembly, the magnetron 2082 can form, by the cathode and anode thereof, a space in which electrons interact with a high-frequency electromagnetic field, microwaves are generated in this space, and the waveguide tube 2084 transmits the generated microwaves into the cavity 2088, such that the microwaves are absorbed by the food to be processed, thereby accomplishing the function of heating, defrosting or the like. Moreover, since the magnetron 2082 also generates a large amount of heat while generating microwaves, the fan assembly 2086 is further provided, and in order to prolong the service life of the magnetron 2082, the fan assembly performs forced air-cooling heat dissipation on the magnetron during the operation of the magnetron to maintain the stability of the operation of the magnetron 2082, and reduce the possibility that the magnetron 2082 is damaged because too much heat accumulates on the magnetron and cannot be dissipated.

According to the embodiment of the present disclosure described above, the cavity assembly further comprises:

the cavity 2088 for receiving the drawer 2044;

a guide rail 2106 connected to the drawer door body 2042 through the connection plate 2048 and used for providing a path for the pulling-out or restoring of the drawer 2044;

at least one interlock bracket 2104 provided in the cavity 2088 and in one-to-one correspondence with the at least one door hook 2046;

at least one limit block 2102 provided at the bottom of the drawer 2044 and used for limiting the opening degree of the drawer assembly;

a first microswitch 2108 that is connected to the microprocessor 202 and is closed and feeds back a signal to the microprocessor 202, when the drawer assembly is opened to a maximum extent; and

a second microswitch 2110 that is connected to the microprocessor 202, and is closed and feeds back a signal to the microprocessor 202, when the door hook 2046 is coupled to the interlock bracket 2104.

In this embodiment, the guide rail 2106 connected to the drawer door body 2042 through the connection plate 2048 provides a path for the pulling-out or retraction of the drawer 2044; moreover, at least one limit block 2102 is provided at the bottom of the drawer 2044, which can limit the maximum pulling-out length of the drawer assembly to reduce the physical injuries to the user when the drawer 2044 is pulled out. Further, it is also feasible to provide a limit block 2102 on each of the two sides of the bottom of the drawer 2044, so that when pulled out to the maximum extent along the guide rail 2106, the drawer 2044 maintains the uniformity of moving of the two sides thereof, and the possibility of the occurrence of the case where the drawer 2044 is pulled out with one side being longer than the other side is reduced.

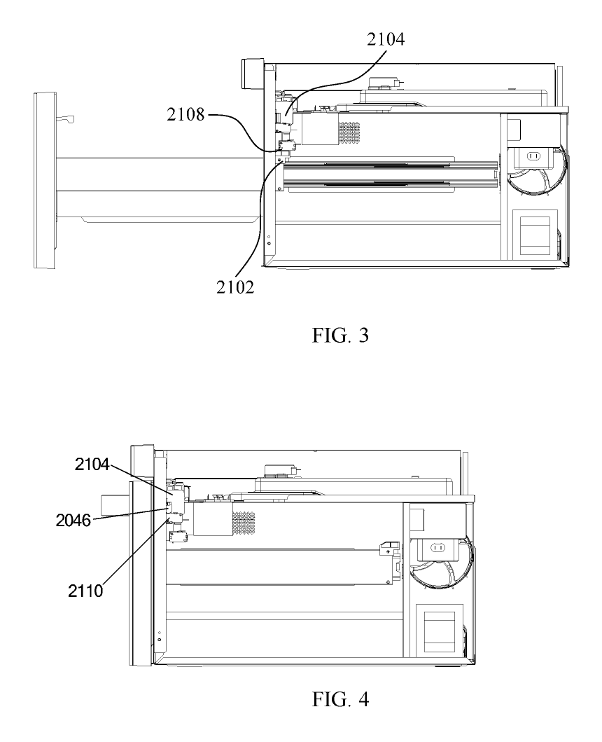

As shown in FIGS. 3 and 4, there are also provided the first microswitch 2108 and the second microswitch 2110, wherein the first microswitch 2108 can be regarded as an opening detection switch, when the drawer assembly is pulled out to the maximum stroke, the limit block 2102 touches the first microswitch 2108 provided on the interlock bracket 2104, at this time, the first microswitch 2108 is closed and transmits a closing signal to the microprocessor 202, and the microprocessor 202 determines that the drawer assembly is in the maximum opened state at this time;

the second microswitch 2110 may be regarded as a closing detection switch, when the drawer assembly is closed, the door hook 2046 is mated with the interlock bracket 2104, and the second microswitch 2110 is triggered at the same time, at this time, the second microswitch 2110 is closed and transmits a closing signal to the microprocessor 202, and the microprocessor 202 determines that the drawer assembly is in the closed state at this time. In the above, the second microswitch 2110 may be a microswitch specifically provided for detecting the closing of the drawer 2044, or a primary interlock switch, a secondary interlock switch, a monitor switch or the like of the drawer-type microwave oven 200 itself may also be used as the second microswitch.

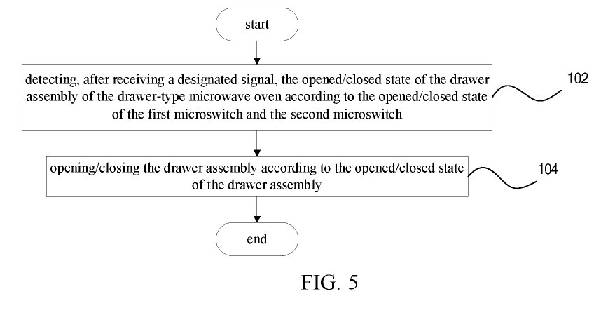

As shown in FIG. 5, an embodiment of the second aspect of the present disclosure provides a door opening and closing control method for the drawer-type microwave oven 200, comprising the following steps:

step 102, detecting, after receiving a designated signal, the opened/closed state of the drawer assembly of the drawer-type microwave oven 200 according to the opened/closed state of the first microswitch 2108 and the second microswitch 2110; and

step 104, opening/closing the drawer assembly according to the opened/closed state of the drawer assembly.

In this embodiment, after the user touches the button located on the control panel 220, the microprocessor 202 will detect the opened/closed state of the first microswitch 2108 and the second microswitch 2110, thereby controlling, by analyzing the state of the two microswitches, the push rod 2062 assembly to push out or retract the drawer 2044.

According to an embodiment of the second aspect of the present disclosure, step 102 further comprises:

if the first microswitch 2108 is in the closed state, the drawer assembly being in the maximum opened state;

if the second microswitch 2110 is in the closed state, the drawer assembly being in the closed state; and if both the first microswitch 2108 and the second microswitch 2110 are in the opened state, the drawer assembly being in the opened state but not opened to the maximum extent.

According to an embodiment of the second aspect of the present disclosure, step 104 further comprises:

closing the drawer assembly if the drawer assembly is in the maximum opened state; opening the drawer assembly to the maximum extent if the drawer assembly is in the closed state; and opening the drawer assembly to the maximum extent if the drawer assembly is in the opened state, but is not opened to the maximum extent.

Specifically, the state analysis process and the determination operation are as shown in Table 2.

TABLE 2

| State of | state of | | |
|---|---|---|---|
| the first | the second | | |
| microswitch | microswitch | initial drawer | push rod 2062 |
| 2108 | 2110 | 2044 state | control operation |
| opened | opened | opened state | opening the |
| | | | drawer assembly |
| | | | to the maximum |
| | | | opened extent |
| opened | closed | closed state | pushing out and |
| | | | opening the |
| | | | drawer assembly |
| closed | opened | maximum opened | retracting and |
| | | state | closing the |
| | | | drawer assembly |

According to an embodiment of the second aspect of the present disclosure, the door opening and closing control method for the drawer-type microwave oven 200 further comprises: if receiving the designated signal during the moving process, the drawer assembly immediately stopping moving.

In this embodiment, during use, in the moving process of the drawer assembly, when the user realizes that the food previously placed is the wrong food, he may press the button, then the microcontroller immediately controls, by determining that the drawer 2044 is currently moving and the first microswitch 2108 and the second microswitch 2110 are not touched, the push rod 2062 assembly to stop moving and wait for the next instruction, which improves the use safety of the user, while improving the user experience.

The technical solutions of the present disclosure have been described above in detail with reference to the accompanying drawings. The present disclosure proposes a novel drawer-type microwave oven and a door opening and closing control method therefor, wherein in the interior of the cavity assembly are provided a push rod assembly for pushing the drawer assembly out of or into the cavity assembly and a control panel connected to a microprocessor. On the one hand, the user can realize the function of automatic opening and the function of automatic closing only by operating one button; and on the other hand, in order to ensure the safety of the user, in the process of opening or closing the drawer assembly, if the user intends to stop the operation of the drawer assembly immediately, he only needs to press the button, then the control of stopping the operation of the drawer assembly can be realized.

In the description of the present specification, the terms “first” and “second” are used for descriptive purposes only and cannot be construed as indicating or implying relative importance; the terms “connection”, “mounting”, “fixation” and the like should be broadly defined, for example, the “connection” may be a fixed connection, may also be a detachable connection, or an integral connection; and it may be directly connected and may also be indirectly connected through an intermediate medium. Those of ordinary skills in the art can understand the specific meanings of the above terms in the present disclosure based on specific situations.

In the description of the present specification, the description of the terms “one embodiment” and the like means that a particular feature, structure, material or characteristic described in combination with the embodiment or example is included in at least one embodiment or example of the present disclosure. In the present specification, the schematic representation of the above terms does not necessarily refer to the same embodiment or example. Furthermore, the particular features, structures, materials or characteristics described may be combined in a suitable manner in any one or more embodiments or examples.

The foregoing descriptions are merely preferred embodiments of the present disclosure and are not intended to limit the present disclosure. For those skilled in the art, the present disclosure may have various modifications and changes. Any modifications, equivalent substitutions, improvements and the like made within the spirit and principle of the present disclosure should be encompassed in the protection scope of the present disclosure.

1-10. (canceled)

11. A drawer-type microwave oven, comprising:
a cavity assembly;
a drawer assembly, provided in an interior of the cavity assembly and used for containing food to be processed;
a push rod assembly, provided at a bottom of the interior of the cavity assembly and capable of pushing the drawer assembly out of or into the cavity assembly;
a control panel, disposed on the cavity assembly, and provided with an “on/off” button for controlling the drawer assembly to be opened or closed; and
a microprocessor, provided in the interior of the cavity assembly and used for controlling an operating state of the push rod assembly according to an instruction of the control panel.

12. The drawer-type microwave oven according to claim 11, wherein the drawer assembly comprises:
a drawer door body having an upper surface being parallel to a lower surface of the control panel;
a drawer for containing and processing the food to be processed;
at least one door hook provided on a rear side of the drawer door body and used for preventing the drawer assembly from ejecting at the time of processing the food to be processed; and
a connection plate connected to the drawer door body and used for enabling the drawer to move according to a preset track when the drawer is pulled out or returned to its original position.

13. The drawer-type microwave oven according to claim 12, wherein the drawer door body further comprises:
a transparent window for displaying a cooking state of the food to be processed; and
a handle for manually pulling out the drawer or manually restoring the drawer.

14. The drawer-type microwave oven according to claim 12, wherein the cavity assembly further comprises:
a cavity for receiving the drawer;
a guide rail connected to the drawer door body through the connection plate and used for providing a path for the pulling-out or restoring of the drawer;
at least one interlock bracket provided in the cavity and in one-to-one correspondence with the at least one door hook;
at least one limit block provided at the bottom of the drawer and used for limiting the opening degree of the drawer assembly;
a first microswitch connected to the microprocessor, wherein the first microswitch is closed and returns a signal to the microprocessor, when the drawer assembly is opened to a maximum extent; and
a second microswitch connected to the microprocessor, wherein the second microswitch is closed and returns a signal to the microprocessor, when the door hook is coupled to the interlock bracket.

15. The drawer-type microwave oven according to claim 11, wherein the push rod assembly comprises:
a push rod connected to the drawer door body;
a motor for driving the drawer under the control of the microprocessor; and
a pusher provided at the bottom of the interior of the cavity assembly and connected to the motor and the push rod to drive the push rod under the driving of the motor.

16. The drawer-type microwave oven according to claim 11, wherein the cavity assembly comprises:
a magnetron for generating microwaves for processing the food to be processed;
a waveguide tube located at a top of the interior of the cavity assembly, connected to the magnetron and used for transmitting ultra-high frequency electromagnetic waves; and
a fan assembly that performs forced air-cooling heat dissipation on the magnetron to prevent the magnetron from overheating damage.
